(19) United States
(12) Patent Application Publication
(10) Pub. No.: US 2025/0266451 A1
(43) Pub. Date: Aug. 21, 2025

(54) Electrochemical Energy-Storage Cells Having Differing Cathodes Composed of Differing Active Materials, and Battery Modules That Include the Same

(71) Applicant: SES Holdings Pte. Ltd., Singapore (SG)

(72) Inventors: Binghong Han, Woburn, MA (US); Zhuhua Cai, Woburn, MA (US); Seung Wan Kim, Woburn, MA (US); Yunya Zhang, Andover, MA (US); Sai Palaparty, Malden, MA (US); Zhengping Zhou, Westford, MA (US); Han Jiang, Wilmington, MA (US); Qiong Luo, Shanghai (CN); Xinbing Chen, Shanghai (CN); Hong Gan, Woburn, MA (US)

(21) Appl. No.: 18/583,740

(22) Filed: Feb. 21, 2024

(51) Int. Cl. H01M 4/58; H01M 4/02; H01M 4/131; H01M 4/505; H01M 4/525; H01M 10/0525; H01M 50/46

(52) U.S. Cl. CPC H01M 4/5825; H01M 4/131; H01M 4/136; H01M 4/505; H01M 4/525; H01M 10/0525; H01M 50/46; H01M 2004/028

(57) ABSTRACT

Electrochemical energy-storage cells and battery modules having cathodes of differing types relative to one another. In some embodiments, at least one of the cathodes is composed of a nickel-containing-oxide based cathode-active material and at least one other of the cathodes is composed of a metal-phosphate based cathode-active material. In some embodiments, mixing multiple types of cathodes with differing cathode-active materials makes each corresponding cell less prone to entering into thermal runaway and/or reduce the intensity of a thermal-runaway event. Methods of designing cells to be less prone to entering into thermal runaway and/or to reduce the intensity of a thermal-runaway event.

### FIELD

The present disclosure generally relates to electrochemical energy storage cells. More particularly, the present disclosure is directed to electrochemical energy-storage cells having differing cathodes composed of differing active materials, and battery modules that include the same.

### BACKGROUND

With the fast expansion of the electric vehicle (EV) market, customers are asking for a longer cruise range, which is closely related to battery energy density. To improve the energy density, in addition to replacing the traditional graphite anodes with higher capacity materials, such as lithium (Li) metal or silicon (Si), a widely acknowledged approach is using NMC (nickel-manganese-cobalt oxide) cathodes that have high concentrations of nickel (Ni) (high-Ni NMC). Compared with NMC111 (Ni:Mn:Co=1:1:1), whose capacity is about 170 mAh/g, NMC900505 (Ni:Mn:Co=90:5:5) can deliver a specific capacity of 220 mAh/g, indicative of a ˜30% improvement in cell energy density. By combining Li-metal anodes with high-Ni NMC cathodes, the resulting battery cells have the potential to reach an energy density of over 1000 Wh/L and a specific energy of over 400 Wh/kg, which are much higher than the state-of-the-art Li-ion batteries.

However, Li-ion and Li-metal cells having NMC cathodes usually exhibited severe thermal-runaway events due to NMC structural collapse and resulting oxygen release at relatively low temperatures. Furthermore, when moving to a higher Ni concentration, the crystal structure of the NMC becomes increasingly unstable, and oxygen tends to be released at lower temperatures, leading to worse thermal stability.

A counterpart to NMC is lithium metal phosphates, such as lithium iron phosphate (LFP) and lithium manganese iron phosphate (LMFP), which are a much safer cathode-active material because they do not release oxygen. However, LFP and LMFP are unable to deliver high energy due to lower specific capacity (˜160 mAh/g) and lower working voltage. Using only LFP cathodes or only LMFP cathodes also has other negative impacts such as worse high-power performance and worse low-temperature performance. So far, there is no effective way to improve intrinsic cell safety with minimum sacrifice of energy density, power density, and/or other properties.

### SUMMARY

In one implementation, the present disclosure is directed to a core for an electrochemical energy-storage cell, which includes a plurality of anodes; a plurality of cathodes, wherein: at least one first cathode of the plurality of cathodes comprises nickel-containing-oxide (NO) active material; and at least one second cathode of the plurality of cathodes comprises metal-containing-phosphate (MP) active material; and a plurality of separators; wherein the plurality of anodes, the plurality of cathodes, and the plurality of separators are arranged to form a stack in which each of the plurality of separators is located between a corresponding anode-cathode pair composed of one of the plurality of anodes and one of the plurality of cathodes.

In another implementation, the present disclosure is directed to a method of constructing an electrochemical energy-storage cell, which includes constructing a core having a plurality of cathodes by: providing at least one first cathode to the plurality of cathodes that comprises nickel-containing-oxide (NO) active material; providing at least one second cathode to the plurality of cathodes, wherein the at least one second cathode comprises metal-containing-phosphate (MP) active material, wherein each of the at least one second cathode has been selected to improve thermal-runaway safety of the electrochemical energy-storage cell; providing a plurality of separators; providing a plurality of anodes; forming the core using the plurality of cathodes, the plurality of separators, and the plurality of anodes.

### BRIEF DESCRIPTION OF THE DRAWINGS

For the purpose of illustration, the accompanying drawings show aspects of one or more embodiments of the disclosure. However, it should be understood that the scope of this disclosure is/are not limited to the precise arrangements and instrumentalities shown in the drawings, wherein:

FIG. 1 is a graph of temperature versus time for a baseline lithium-metal secondary cell having 32 lithium-metal anodes and 31 cathodes each composed of nickel manganese cobalt oxide (NMC) active material, wherein the cell was heated at a rate of 5° C./min until thermal runaway occurred, showing that thermal runaway began at 220° C.;

FIG. 2 is a graph of temperature versus time for a lithium-metal secondary cell in which 7 of the 31 NMC cathodes of the cell of FIG. 1 were replaced with cathodes composed of lithium iron phosphate (LFP) active material, wherein the cell was heated at a rate of 5° C./min until thermal runaway occurred, showing that thermal runaway began at 348° C.;

FIG. 3 is a graph of temperature versus time for a lithium-metal secondary cell in which 11 of the 31 NMC cathodes of the cell of FIG. 1 were replaced with LFP cathodes and the cell was heated at a rate of 5° C./min until thermal runaway occurred, showing that thermal runaway began at 401° C.;

FIG. 4 is a graph of temperature versus time for a lithium-metal secondary cell in which 15 of the 31 NMC cathodes of the cell of FIG. 1 were replaced with LFP cathodes and the cell was heated at a rate of 5° C./min until thermal runaway occurred, showing that thermal runaway began at 401° C.;

FIG. 5 is a graph of temperature versus time for a lithium-metal secondary cell in which all of the 31 NMC cathodes of the cell of FIG. 1 were replaced with LFP cathodes and the cell was heated at a rate of 5° C./min until thermal runaway occurred, showing that thermal runaway began at 434° C.;

FIG. 6 is a graph of thermal-runaway temperature versus percentage of LFP cathodes relative to the total number of cathodes, showing the effect of the percentage of LFP cathodes on thermal-runaway temperature;

FIG. 7A is a photograph of the baseline cell of FIG. 1 during thermal runaway, showing the resulting high-intensity burning of the cell;

FIG. 7B is a photograph of the cell of FIG. 2 during thermal runaway, showing the reduced intensity of the resulting fire and the impact of having ˜20% of the 31 cathodes being LFP cathodes;

FIG. 8A is an idealized diagram of an electrochemical cell made in accordance with the present disclosure and thereby having a core comprising a mixture of cathodes having differing active materials;

FIG. 8B is an idealized diagram of a battery module composed of a plurality of the electrochemical cells of FIG. 8A;

FIG. 9A is a cross-sectional view of a cell core composed of 17 anodes, 16 cathodes, and 17 dielectric separators located between adjacent ones of the anodes and cathodes, with O-cathodes and P-cathodes alternating with one another so as to provide the cell core with a %-ratio of P-cathodes to total cathodes of 50%;

FIG. 9B is a cross-sectional view of a cell core composed of 17 anodes, 16 cathodes, and 17 dielectric separators located between adjacent ones of the anodes and cathodes, with adjacent P-cathodes being spaced apart from one another by three intervening O-cathodes so as to provide the cell core with a %-ratio of P-cathodes to total cathodes of 25%;

FIG. 9C is a cross-sectional view of a cell core composed of 17 anodes, 16 cathodes, and 17 dielectric separators located between adjacent ones of the anodes and cathodes, with adjacent P-cathodes being spaced apart from one another by five intervening O-cathodes so as to provide the cell core with a %-ratio of P-cathodes to total cathodes of about 19%;

FIG. 9D is a cross-sectional view of a cell core composed of 17 anodes, 16 cathodes, and 17 dielectric separators located between adjacent ones of the anodes and cathodes, with P-cathodes being located only at the opposite ends of the core stack and in a number that provides the cell core with a %-ratio of P-cathodes to total cathodes of about 38%;

FIG. 9E is a cross-sectional view of a cell core composed of 17 anodes, 16 cathodes, and 17 dielectric separators located between adjacent ones of the anodes and cathodes, with P-cathodes being located at one end of the core stack and provided in a number that provides the cell core with a %-ratio of P-cathodes to total cathodes of about 31%; and

FIG. 9F is a cross-sectional view of a cell core composed of 17 anodes, 16 cathodes, and 17 dielectric separators located between adjacent ones of the anodes and cathodes, with side-by-side pairs of P-cathodes being spaced apart from one another by four intervening O-cathodes so as to provide the cell core with a %-ratio of P-cathodes to total cathodes of about 38%.

### DETAILED DESCRIPTION

The technical content of the appended claims is incorporated by reference into this Detailed Description section so that such content is included herein as if it were literally present in this section.

It is noted that throughout the present disclosure and the appended claims, the term “about”, when used with a corresponding numeric value, refers to ±20% of the numeric value, typically ±10% of the numeric value, often ±5% of the numeric value, and more often ±2% of the numeric value. In some embodiments, the term “about” means the numeric value itself.

As used herein and in the appended claims, the term “cathode” covers the combination of cathode-active material and any current collector(s) provided for that cathode in any given cathode layer of a core of an electrochemical energy-storage cell. Those skilled in the art will readily appreciate that a cathode may contain one or more other components, such as one or more inert components and/or one or more components for enhancing performance of the cathode and/or for constructing the core, among others. Examples of cathodes of the present disclosure include cathodes having a current collector layer sandwiched between two active-material layers and cathodes having a current collector and a single active-material layer located on one face of the current collector, among others.

### Overview

In some aspects, the present disclosure is directed to core stacks of electrochemical energy-storage cells in which each core stack includes multiple anodes, multiple dielectric separators, and multiple cathodes all stacked with one another to form a functional core and wherein the cathodes comprise at least one cathode composed of a cathode-active material that is different from the cathode-active material of at least one other of the cathodes. The electrochemical energy-storage cells, or simply “cells” hereinafter, may be any type of cells, including, but not limited to cells based on alkali-metal-ion flow, such as lithium-ion flow, sodium-ion flow, and potassium-ion flow, among others, or the flow of ions of one or more other chemical species. In addition, the electrodes of cells of the present disclosure may be based on plating and stripping or intercalation and de-intercalation or a combination thereof, and/or other type of ion accumulation and de-accumulation. For example, a cell of the present disclosure may be a lithium-ion cell or a lithium-metal cell, among others, each of which may be a secondary cell or a primary cell. It is noted that the term “core” as used herein and in the appended claims covers any sort of core for a cell that includes multiple layers comprising anode layers, separator layers, and cathode layers located immediately adjacent to one another to at least have the appearance of a stack of such layers. Consequently, a “core” of the present disclosure includes truly stacked cores each composed of individual sheets defining the various layer, cores formed by the Z-fold method, and “jellyroll” cores, among others.

Improving the safety of cells, such as Li cells (including both Li-ion and Li-metal cells), with high-nickel (Ni) cathodes is a critical step toward long-range electric vehicles (EVs). However, no method appears to have been developed to effectively improve safety with minimal impacts on energy density. An aim of the present disclosure is to improve cell intrinsic safety by mixing cathode types within a cell's core in a certain ratio. In some embodiments, one of the cathode types is a high-nickel-content-oxide type, or “O type”, and another of the types is a metal-phosphate type, or “P type”. The present inventors have unexpectedly discovered that by providing a cell with both O-and P-type cathodes (or more simply, “O-cathodes” and “P-cathodes” hereinafter) in certain ratios, the one or more P-cathodes can reduce the amount of oxygen available during thermal runaway, scavenge flammable gases, and/or discharge the O-cathodes at high temperature, while also minimizing the negative effect that the P-cathode(s) present would have on the energy density of the cell.

At a high level, the P-cathode(s) is/are electrically connected to the O-cathodes and have the ability to scavenge flammable/explosive gases, prevent heat propagation, and/or discharge the O-cathodes under abuse conditions. This can either cut off the thermal runaway chain reaction and/or improve the materials' thermal stability, leading to better thermal-runaway safety at the cell level. Since the thickness, proportion, and materials of the P-cathode(s) can be flexibly adjusted, it is possible to achieve cell intrinsic thermal-runaway safety with minimal impacts on the energy density and electrochemical performance of the cell. Testing has shown that the thermal runaway temperature can be increased and the severity can be decreased by using proper mixing methods.

In some aspects, the present disclosure is directed to methods of designing cells to improve their thermal-runaway safety. As mentioned above and discussed in more detail below, thermal-runaway safety can be improved by raising the thermal-runaway-initiation temperature, causing one or more certain cathodes within the cells to discharge quicker, and/or absorbing gas generated during elevated temperature events, among others.

In some embodiments, the thermal-runaway safety of a cell is improved by designing a cell that would otherwise include only O-cathodes to include one or more P-cathodes, wherein each P-cathode is composed of a cathode-active material that improves, relative to a baseline cell having only O-cathodes, the thermal-runaway safety of the cell. By “baseline cell”, it is meant that the baseline cell is identical to a corresponding P-cathode-containing cell in every respect other than the fact that it does not include any P-cathodes. Detailed examples of how one or more P-cathodes can be included in a cell are presented below. Relatedly, in some aspects, the present disclosure is directed to methods of constructing a cell having improved thermal-runaway by including one or more P-cathodes within a design that is otherwise based on O-cathodes.

### Working Principles

As alluded to above, a goal of the present disclosure is to improve safety of high-energy cells, such as high-energy Li cells (including both Li-ion and Li metal cells), by mixing P- and O-cathodes with one another in a cell's core. Without necessarily limiting this disclosure to any particular theories of operation, this goal appears to depend on the following operating mechanism:
1) Metal phosphates have very stable crystal structures that do not release oxygen at high temperatures. Therefore, the inclusion of one or more P-cathodes in a core improves the thermal stability of the high-Ni O-cathodes.
2) Metal phosphates may react with the gases generated within the cell, reducing the total gas amount and consuming flammable/explosive gases.
3) Metal phosphates may trigger shuttling effects or other side reactions under abuse conditions such as at high temperatures, which may discharge the electrically connected O-cathodes to a lower state of charge and thereby improve the thermal stability of the cathode-active material of the O-cathodes.
   These mechanisms can either work alone or together.

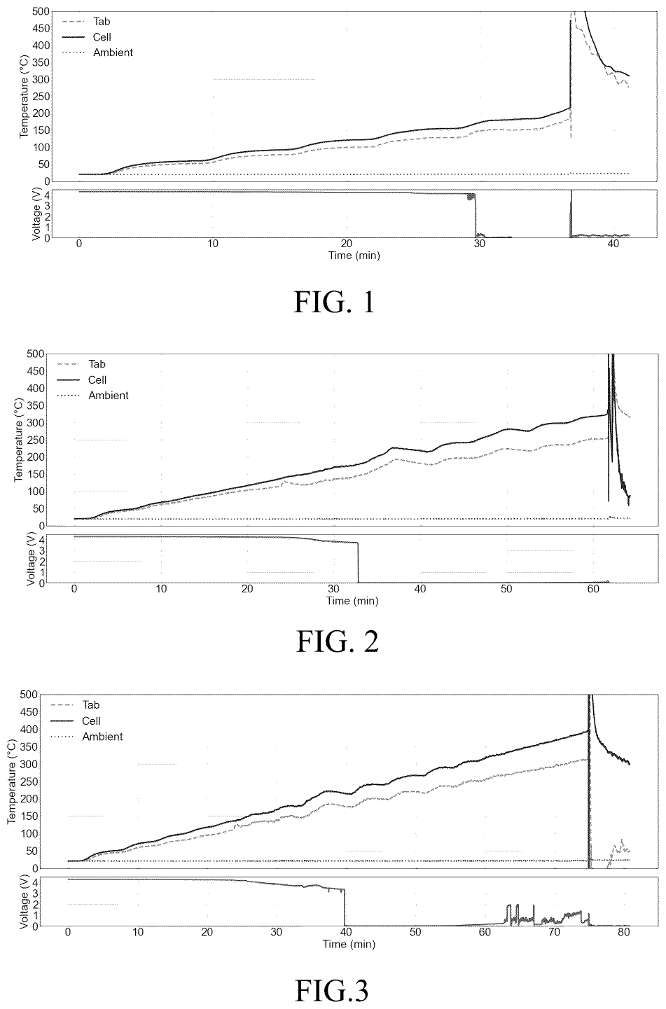

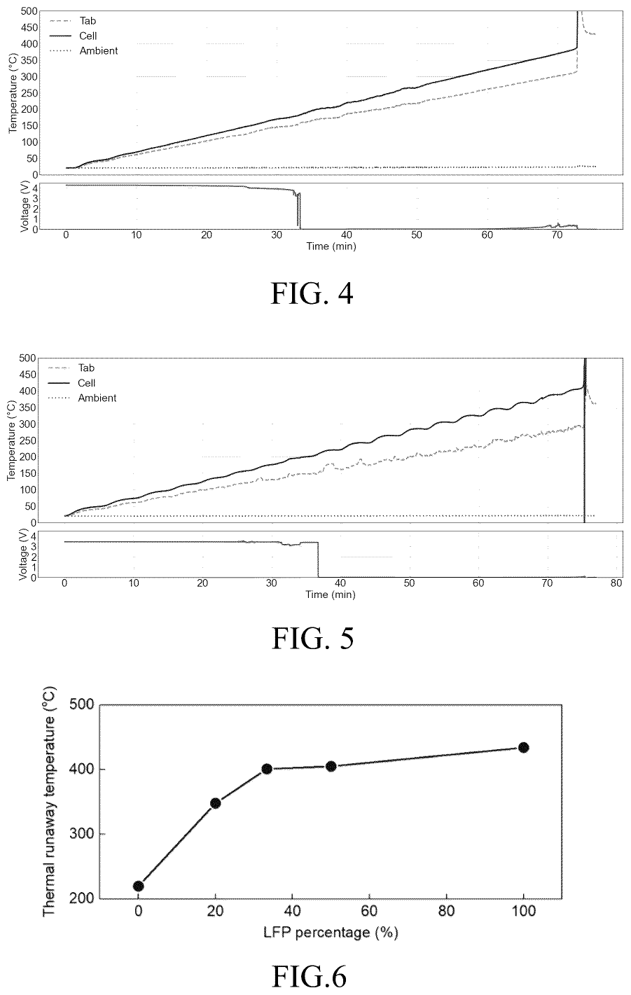

To demonstrate efficacy of mixing cathode types within a particular cell core, lithium iron phosphate (LFP) based cathodes were mixed with nickel manganese cobalt oxide (NMC) based cathodes. The LFP cathodes were inserted into the cells with a liquid electrolyte in differing ratios. The test cells were originally designed to contain only NMC cathodes, such that the inserted LFP cathodes replaced various ones of the original NMC cathodes. Then, the cells were heated at 5° C./min until thermal runaway was initiated. For the cell not having any LFP cathodes inserted, this 4 Ah (31 layers of NMC cathodes and 32 layers of Li-metal anodes) cell went to thermal runaway at 220° C., as seen in FIG. 1. When one LFP cathode was inserted between every 4 NMC cathodes (in total, 7 layers of LFP cathodes and 24 layers of NMC cathodes, i.e., the LFP cathodes were ˜20% of all cathodes), the thermal runaway temperature increases to 348° C., as seen in FIG. 2. When the ratio of the LFP cathodes to total number of cathodes was increased to 33.3%, indicating that every two NMC cathodes had one corresponding LFP cathode (in total, 11 layers of LFP cathodes and 20 layers of NMC cathodes), the thermal runaway temperature increased to 401° C., as seen in FIG. 3. When the ratio of LFP cathodes further increased to ˜50%, with the NMC cathodes and the LFP cathodes were stacked alternatingly and interdigitatingly with one another, the thermal runaway temperature had a minor increase to 401° C., as seen in FIG. 4.

When all the NMC cathodes were replaced by LFP cathodes, the thermal runaway temperature increases to 434° C. (FIG. 5). This testing revealed that adding a few LFP cathodes, relative to the total number of cathodes, can notably increase the thermal runaway temperature, with the trend showing a logarithmic pattern (FIG. 6). In addition, in FIGS. 2 through 5, when LFP cathodes are provided, the cell voltage showed an early decrease around 150° C., which supports the above-mentioned theory that metal phosphates may trigger shuttling effects or other side reactions to discharge the electrically-connected NMC to a lower state of charge and thereby improve the thermal stability of the NMC cathodes.

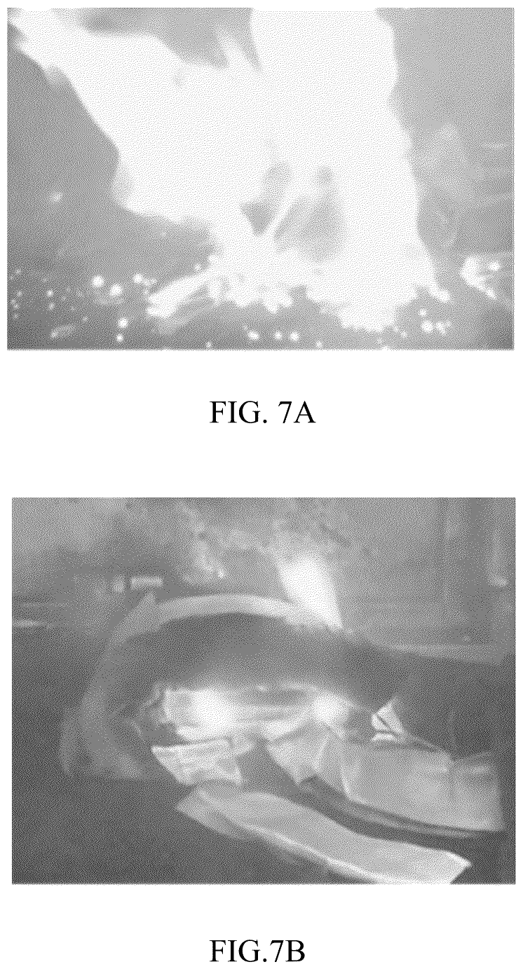

In addition to the increased thermal runaway temperature, the severity of thermal runaway can also be reduced by including one or more LFP cathodes among the NMC cathodes of a cell's core. As shown in FIG. 7A, the benchmark cell of FIG. 1 containing only NMC cathodes had a very aggressive burning at the thermal runaway. In contrast and as shown in FIG. 7B, the cell of FIG. 2 made in accordance with the present disclosure that had ˜20 % of the total number of cathodes being LFP cathodes exhibited only flame and smoke after the thermal runaway, without the sound of the explosion. These results demonstrate that mixing one or more metal-phosphate-based cathodes, such as LFP cathodes, with nickel-containing-oxide-based cathodes, such as NMC cathodes, can effectively reduce the severity of the thermal runaway event.

Nail penetration tests were also performed. While the benchmark cell having only NMC cathodes exploded after a 10 mm/s nail penetration tests (using a 3 mm-diameter stainless steel nail), the above-mentioned cell having 11% of the cathodes as LFP cathodes passed the 40 mm/s nail penetration tests without triggering any thermal event after the nail penetrated the center of the cell. This result demonstrates that mixing one or more metal-phosphate-based cathodes, such as LFP cathodes, with nickel-containing-oxide-based cathodes, such as NMC cathodes, is also helpful in improving the safety of cells in penetration events.

### GENERAL EXAMPLES

In some embodiments, there are two differing cathode-active materials used on differing ones of the cathodes, namely, a nickel-containing-oxide (NO) active material and a metal-containing-phosphate (MP) active material. The NO active material can be any suitable metal-based oxide that includes nickel. This includes pure nickel oxide and nickel in combination with one or more other metals, such as manganese and cobalt, among others. When the NO active material contains nickel in combination with one or more other metals other than the active-species metal of the ionic flow within the cell, the nickel may be present in a stoichiometric percentage relative to the metal content only, up to 100%.

In some embodiments, it may be desirable to use an NMC as the NO active material. The general formula for NMC is MNiₓMn_{y}, Co_{1-x-y}O₂, wherein M is the active-species metal of the cell (such as Li or Na, for example), 1>x>0, and 1>y>0. In some embodiments, x is greater than about 0.4, greater than about 0.5, greater than about 0.6, greater than about 0.7, greater than about 0.8, greater than about 0.85, or greater than about 0.9 or is equal to about 0.95. In some embodiments, x is in a range of about 0.5 to about 0.95, in a range of about 0.6 to about 0.95, in a range of about 0.7 to about 0.95, in a range of about 0.9 to about 0.95, or in a range of about 0.5 to about 0.95. In some nonlimiting embodiments, the NMC may be, for example, NMC950302 (95% Ni; Ni:Mn:Co=95:03:02) NMC900505 (90% Ni, as noted above), NMC811 (80% Ni; Ni:Mn:Co=80:10:10), NMC622 (60% Ni; Ni:Mn:Co=60:20:20), or NMC532 (50% Ni; Ni:Mn:Co=50:30:20), among others.

The MP active material can be any suitable metal-based phosphate. Examples of metals that can be used in the MP active material include transition metals, such as, but are not limited to, iron (Fe), Mn, Co, chromium (Cr), or Ni, and post-transition metals, such as aluminum (Al) and gallium (Ga), among others, or any combination or subcombination thereof. For example the MP active material may be iron phosphate (FP) or manganese iron phosphate (MFP), among many other possibilities, and any combination thereof. When the active species of the cell is lithium, the MP active material may be a lithiated version of the underlying MP. For example, the MP may be LFP or LMFP, or a combination of LFP and LMFP. Other examples of MP active materials include, but are not limited to, FePO₄, Zn₃(PO₄)₂, Mg₃(PO₄)₂, Cu₃(PO₄)₂, AlPO₄, and Ni₂(PO₄)₃, among others. As noted, the MP active material can be a mixed metal phosphate, such as, Fe₁₋ₓMnₓPO₄, wherein 1>x>0, among others.

The amount of NO active material present within the cathode-active material of a given cathode can range from greater than 0% to 100% by stoichiometric percentage relative to the total amount of the active materials in the cathode-active material. For example, the amount of NO active material may be in a range of about 50% to 100%, in a range of about 60% to 100%, in a range of about 70% to 100%, in a range of about 80% to 100%, or in a range of about 90% to 100%, among others. In some embodiments, an NO-active-material-containing cathode-active material may be composed of an MP active material. In some embodiments, the NO active material makes up 100% of the active material in the cathode-active material of a given cathode.

Similarly, the amount of MP active material present within the cathode-active material of a given cathode can range from greater than 0% to 100% by stoichiometric percentage relative to the total amount of the active materials in the cathode-active material. For example, the amount of MP active material may be in a range of about 50% to 100%, in a range of about 60% to 100%, in a range of about 70% to 100%, in a range of about 80% to 100%, or in a range of about 90% to 100%, among others. In some embodiments, an MP-active-material-containing cathode-active material may be composed of an NO active material. In some embodiments, the MP active material makes up 100% of the active material in the cathode-active material of a given cathode. In some examples, when the cathode-active material is 100% MP active material, the MP active material may be provided as a layer of any suitable thickness, such as in a range of about 5 microns to about 200 microns, among others.

The number, P, of cathodes containing MP active material included in a given core having a total number, C, of cathodes can be expressed as a %-ratio, R=P/C×100, wherein 0%<R<100%, wherein, in some embodiments, the balance of the cathodes not containing any MP active material are cathodes containing NO active material. In some embodiments it is desirable to include fewer cathodes containing MP active material than cathodes containing NO active material. This is so when the MP-active-material-containing cathodes, i.e., here, the “P-cathodes”, have a lower specific capacity than the NO-active-material-containing cathodes, i.e., here, the “O-cathodes”. In these embodiments R is less than 50%, such as less than about 40%, less than about 30%, less than about 20%, less than about 10%, or less than about 5%, among other percentages, depending, for example, on the composition of the NO active material.

The arrangement of the differing cathodes relative to one another can be executed in any one of a variety of ways. For example, in the context of P-cathodes and O-cathodes, the P-cathodes can be interdigitated with the O-cathodes and deployed singly relative to one another so that immediately adjacent ones of the P-cathodes are separated by one or more O-cathodes. In some embodiments, two or more P-cathodes may be located adjacent to one another, i.e., without any intervening O-cathode. Those skilled in the art will readily appreciate that there is a wide variety of ways in which P-cathodes and O-cathodes can be arranged relative to one another in a particular cell core.

In some embodiments, the P-cathodes may be electrically connected with the O-cathodes in a manner to participate in the electrical circuit that provides the energy output of the cell. In some embodiments, the P-cathodes may not be electrically connected and, therefore, not participate in providing the energy output of the cell. In such latter embodiments, the P-cathodes may be considered idle and inactive relative to the energy output of the cell. In some embodiments, one or more of multiple P-cathodes may participate in the output of the cell while one or more other P-cathodes may be idle and inactive.

### DETAILED EXAMPLES

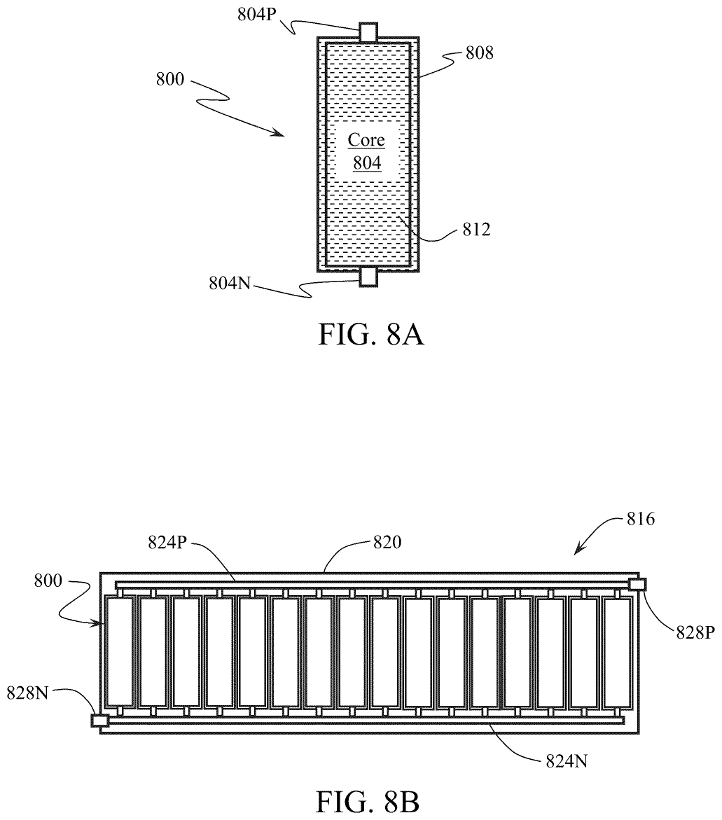

FIG. 8A illustrates an example cell 800 having a core 804 contained within a suitable housing 808. The cell 800 may be of any suitable type, such as any of the types mentioned above, such as a pouch type (e.g., with the core 804 being a stacked core, a Z-fold core, etc.) a cylindrical type (e.g., with the core being a wound type, a jellyroll type, etc.), or a prismatic type (e.g., with the core being a stacked core, a Z-fold core, etc.), among others. Correspondingly, the housing 808 may be of any suitable and corresponding type, such as a pouch or a cylindrical container or a prismatic container, among others. Fundamentally, there are no limitations on the form of the cell 800. As discussed above, the core 804 must have multiple cathodes (not shown), with at least one of the cathodes being of a type different from at least one other cathode. For example, the differing cathodes may be of the O and P types described above and illustrated below. The cell 800 includes positive and negative terminals 804P and 804N, respectively, that electrically connect the corresponding ones of the anodes and cathodes within the core 804 to the exterior of the cell.

The cell further includes an electrolyte 812, which may be any electrolyte suitable for the type and chemistry of the particular version of the cell 800 at issue. In the example shown, the electrolyte 812 is a liquid electrolyte composed of one or more anhydrous organic solvents, one or more salts with the appropriate active species, and/or one or more suitable additives. While the electrolyte 812 is illustrated as a liquid, in other embodiments the electrolyte may be or further provided in one or more other forms, such as a gel and/or a solid. Fundamentally, there are no constraints on the electrolyte, liquid, solid, or a mixture of solid and liquid. Nonlimiting examples of electrolytes that electrolyte 812 can be or contain include, but are not limited to any one or more of the electrolytes disclosed in International Publication No. WO 2023/131930 titled “ELECTROLYTES CONTAINING AN AMIDE-BASED SOLVENT SYSTEM, AND ELECTROCHEMICAL DEVICES INCORPORATING SUCH ELECTROLYTES, published on Jul. 13, 2023, U.S. Patent Application Publication No. US 2024/0030493, titled “ELECTROLYTES HAVING NON-FLUORINATED HYBRID-ETHER COSOLVENT SYSTEMS, METHODS OF MAKING SUCH ELECTROLYTES, AND ELECTROCHEMICAL DEVICES UTILIZING SUCH ELECTROLYTES,” published on Jan. 25, 2024, U.S. Patent Application Publication No. US 2024/0014446, titled “SULFONYL-BASED ELECTROLYTE SOLVENTS ELECTROLYTES MADE THEREWITH, AND ELECTROCHEMICAL DEVICES MADE USING SUCH ELECTROLYTES,” published on Jan. 11, 2024, U.S. Pat. No. 10,615,457, titled “ELECTROLYTE SYSTEM FOR HIGH VOLTAGE LITHIUM ION BATTERY”, issued on Apr. 7, 2020, U.S. Pat. No. 11,196,088, titled “LOCALIZED HIGH-SALT-CONCENTRATION ELECTROLYTES CONTAININER LONGER-SIDECHAIN GLYME-BASED SOLVENTS AND FLUORINATED DILUENTS, AND USES THEREOF”, issued on Dec. 7, 2021, each of which is incorporated herein for its teachings on electrolytes.

FIG. 8B illustrates a battery module 816 that can be made by providing multiple ones of the cell 800 of FIG. 8A within a suitable housing 820. The battery module 816 may be any type of battery module that is composed of multiple cells, here, cells 800, and is designed to suit a particular design. For example, the battery module 816 may be a standalone battery or a battery pack that is part of a larger battery composed of multiple battery packs electrically connected together with one another. The cells 800 are electrically connected together with one another in electrical series and/or electrical parallel using one or more positive bus bars (singly and collectively represented at positive bus bar 824P) and one or more negative bus bars (singly and collectively represented at negative bus bar 824N) so as to achieve the design electrical output characteristics of the battery module. Those skilled in the art will readily understand how to electrically connect the multiple cells 800 with one another to achieve the design electrical output characteristics of the battery module 816. The battery module 816 also includes positive and negative output terminals 828P and 828N that, respectively, are electrically connected to the positive and negative bus bar 824P and 824N for electrically connecting the battery module to another battery module (not shown) and/or a load (not shown) that the battery module is designed to power. Not shown are components that may be provided to support the operation of the battery module 816, such as, but not limited to, one or more sensor systems (e.g., a temperature monitoring sensor system), and onboard electronics, such as a battery management system, among other things. Those skilled in the art will readily understand what additional components that the battery module 816 will need to include for any particular design.

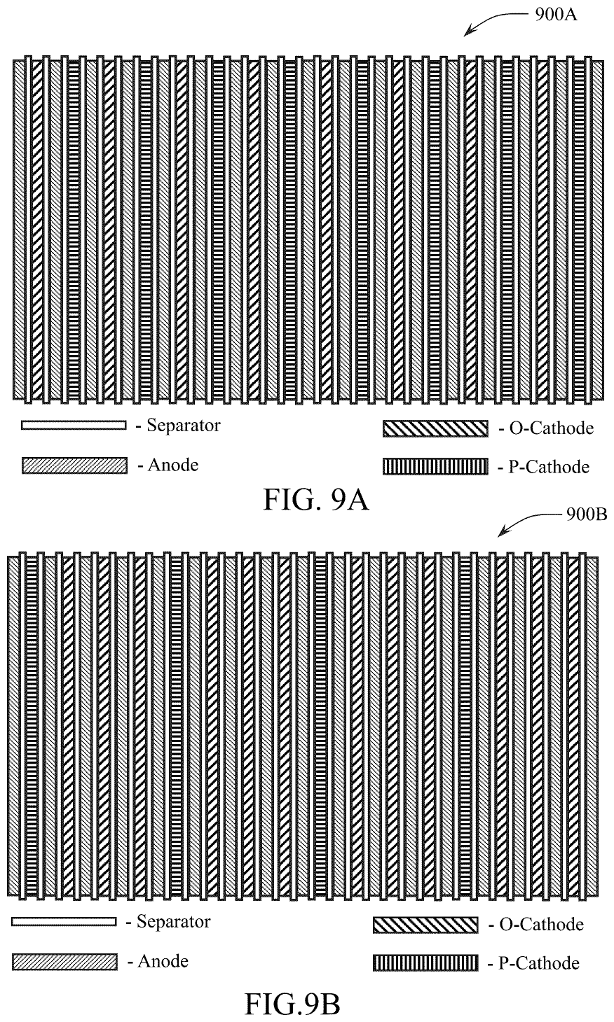

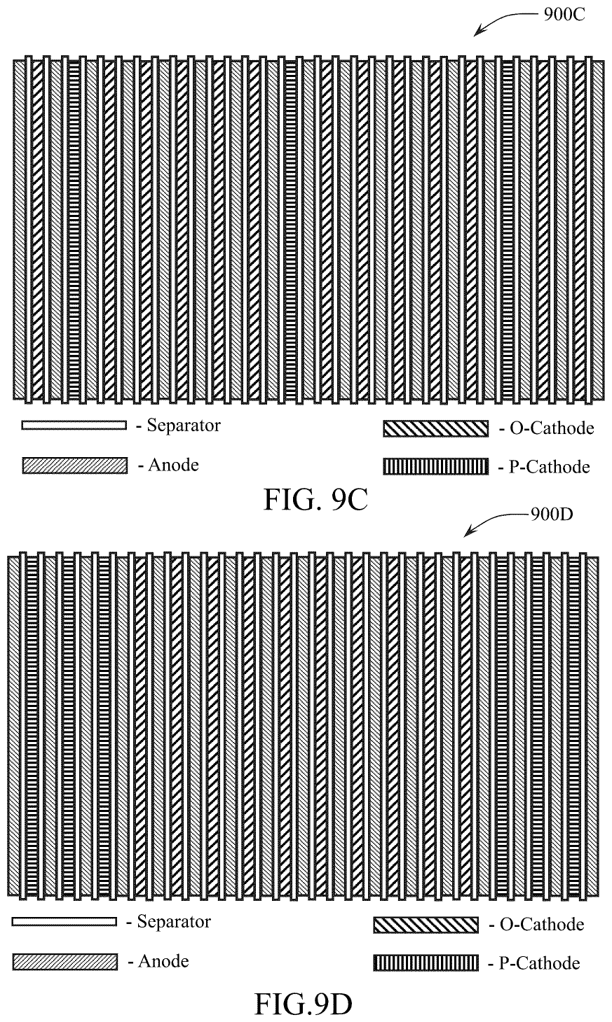

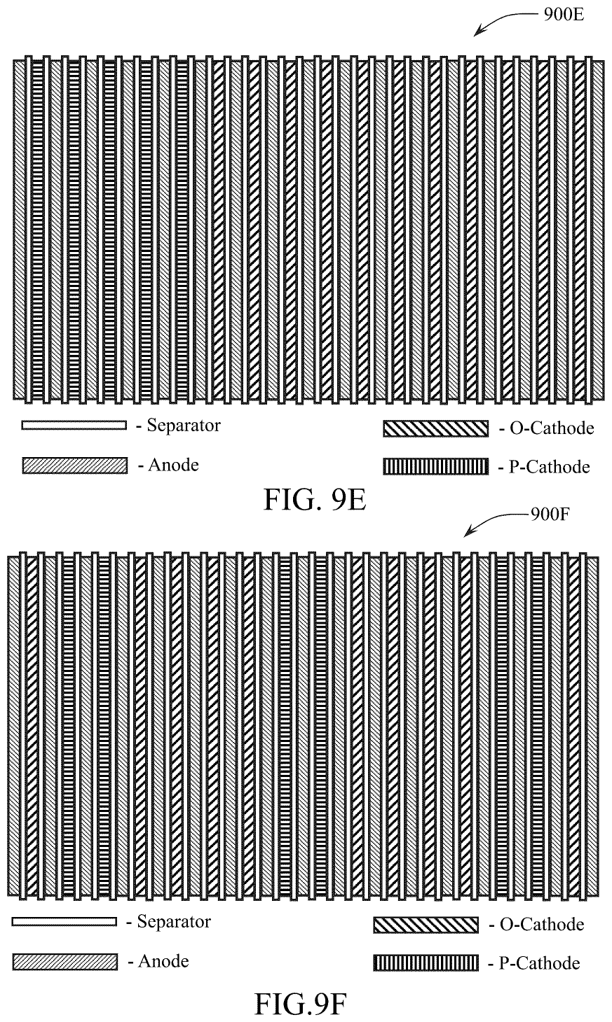

FIGS. 9A through 9F illustrate, respectively, example cores 900A through 900F. In each case, each core has 17 anodes, 16 cathodes, and 17 separators, with some of the cathodes being O-cathodes and some of the cathodes being P-cathodes that each can be any of the O-and P-cathodes described above. Those skilled in the art will readily understand that each of the cores 900A through 900F can be used in any suitable cell, such as the cell 800 of FIG. 8A, among others. Those skilled in the art will appreciate that the numbers of anodes, cathodes, and separators illustrated in these examples have been selected for illustration purposes only and that actual cores made in accordance with the present disclosure may have more or fewer of each of these components. Moreover, those skilled in the art will understand that FIGS. 9A through 9F are simplifications of actual cores and, therefore, lack details, such as, among other things, current collectors and corresponding tabs and other layers that may be separate from or incorporated into one or more of the anodes, cathodes, and separators. Such additional components are beyond the scope of this disclosure but within the knowledge of those having ordinary skill in the art, such that they do not need to be described herein for those skilled in the art to make and use cores, cells, and battery modules of the present disclosure without undue experimentation.

Each of the anodes of FIGS. 9A through 9F can be any suitable type of anode, such as the anodes described above. Similarly, each of the cathodes of FIGS. 9A through 9F, including the O-cathode and P-cathode species, may be any of the cathodes, O-cathodes, and P-cathodes discussed above. Likewise, each of the separators shown in FIGS. 9A through 9F can be any suitable dielectric separator comprising any one or more suitable materials such as, but by no means limited to, a polyethylene, a polypropylene, and a ceramic, among others.

FIG. 9A shows the core 900A as having O-cathodes and P-cathodes located so that they are interdigitated with one another in a sequentially alternating manner so that there are 8 P-cathode out of 16 total cathodes for a %-ratio of P-cathodes to total cathodes of 50%. FIG. 9B shows the core 900B as having 4 P-cathodes with immediately adjacent ones of the P-cathodes separated by three intervening O-cathodes. This gives the core 900B a %-ratio of P-cathodes to total cathodes of 25%. FIG. 9C shows the core 900C as having 3 P-cathodes with immediately adjacent ones of the P-cathodes separated by five intervening O-cathodes. This gives the core 900C a %-ratio of P-cathodes to total cathodes of about 19%. FIG. 9D shows the core as having 6P-cathodes, with 3 of the P-cathodes being located at each end of the core stack. This give the core 900D a %-ratio of about 38%. FIG. 9E shows the core as having 5 P-cathodes all located at one end of the core stack. This give the core 900E a %-ratio of about 31%. FIG. 9F shows the core 900F as having 3 pairs of P-cathodes with immediately adjacent ones of the P-cathode pairs separated by four intervening O-cathodes. This gives the core 900F a %-ratio of P-cathodes to total cathodes of about 38%. Those skilled in the art will readily understand that the four illustrated arrangements of P-cathodes and O-cathodes are merely exemplary and non-limiting. Indeed, many other arrangements are possible. It is noted that while FIGS. 9A through 9F show specific arrangements and positions of the P-cathodes within the respective cores 900A through 900F, the position(s) of the P-cathode(s) within any core can be different from any position(s) shown or suggested. In some embodiments, the effectiveness of the P-cathode(s) is/are independent of their position(s) within a core.

Further features and alternative embodiments of the present disclosure are outlined in this and the following paragraphs. In one embodiment, a method of constructing an electrochemical energy-storage cell, which includes constructing a core having a plurality of cathodes by: providing at least one first cathode to the plurality of cathodes that comprises nickel-containing-oxide (NO) active material; providing at least one second cathode to the plurality of cathodes, wherein the at least one second cathode comprises metal-containing-phosphate (MP) active material, wherein each of the at least one second cathode has been selected to improve thermal-runaway safety of the electrochemical energy-storage cell; providing a plurality of separators; providing a plurality of anodes; forming the core using the plurality of cathodes, the plurality of separators, and the plurality of anodes.

Embodiments disclosed herein include providing at least one second cathode includes providing at least one second cathode comprising the MP active material selected to raise a thermal-runaway temperature of the electrochemical energy-storage cell relative to a baseline thermal-runaway of a baseline electrochemical energy-storage cell that is constructed according to the method of claim 31 but with only the at least one first cathode.

Embodiments disclosed herein include, wherein the electrochemical energy-storage cell is designed to provide an energy output during use, the method further comprising electrically connecting the at least one second cathode so that each of the at least one second cathode participates in providing the energy output.

Embodiments disclosed herein include, wherein the electrochemical energy-storage cell is designed to provide an energy output during use, the method further comprising electrically connecting the at least one second cathode so that each of the at least one second cathode does not participate in providing the energy output.

Embodiments disclosed herein include, wherein the electrochemical energy-storage cell is an alkali-metal cell.

Embodiments disclosed herein include, wherein each of the plurality of anodes is a plating/stripping-type anode.

Embodiments disclosed herein include, wherein the electrochemical energy-storage cell is a lithium cell.

Embodiments disclosed herein include, wherein each of the plurality of anodes is an intercalating/de-intercalating-type anode.

Embodiments disclosed herein include, wherein the electrochemical energy-storage cell is a lithium cell.

Embodiments disclosed herein include, wherein the NO active material comprises one or more transition metals that include nickel, with the nickel present in a stoichiometric range, relative to the one or more transition metals, of about 33% to about 100%.

Embodiments disclosed herein include, wherein the MP active material comprises iron phosphate.

Embodiments disclosed herein include, wherein the MP active material comprises manganese iron phosphate.

Embodiments disclosed herein include, wherein the electrochemical energy-storage cell is a lithium cell.

Embodiments disclosed herein include, wherein each of the plurality of anodes is a plating/stripping-type anode.

Embodiments disclosed herein include, wherein the NO active material comprises a nickel-manganese-cobalt (NMC) material.

Embodiments disclosed herein include, wherein the NMC material contains nickel in a stoichiometric range, relative to amounts of the nickel, manganese, and cobalt in the NMC material, of about 50% to about 90%.

Embodiments disclosed herein include, wherein the MP active material comprises iron phosphate.

Embodiments disclosed herein include, wherein the MP active material comprises manganese iron phosphate.

Embodiments disclosed herein include, wherein the electrochemical energy-storage cell is a lithium cell.

Embodiments disclosed herein include, wherein each of the plurality of anodes is a plating/stripping-type anode.

Embodiments disclosed herein include, wherein the MP active material comprises iron phosphate.

Embodiments disclosed herein include, wherein the MP active material comprises manganese iron phosphate.

Embodiments disclosed herein include a plurality of the first cathodes and a plurality of the second cathodes.

Embodiments disclosed herein include, wherein the first cathodes and the second cathodes are stacked interdigitatingly relative to one another.

Embodiments disclosed herein include, wherein the first and second cathodes alternate one by one with one another.

Embodiments disclosed herein include, wherein the plurality of cathodes are provided in a number C and the at least one second cathode is provided in a number P, wherein a %-ratio of P to C is less than 50%.

Embodiments disclosed herein include, wherein the plurality of cathodes are provided in a number C and the at least one second cathode is provided in a number P, wherein a %-ratio of P to C is less than about 40%.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. (canceled)

2. (canceled)

3. (canceled)

4. The electrochemical energy-storage cell of claim 27, wherein the electrochemical energy-storage cell is an alkali-metal cell.

5. The electrochemical energy-storage cell of claim 4, wherein each of the plurality of anodes is a plating/stripping anode.

6. The electrochemical energy-storage cell of claim 5, wherein the electrochemical energy-storage cell is a lithium cell.

7. The electrochemical energy-storage cell of claim 4, wherein each of the plurality of anodes is an intercalating/de-intercalating anode.

8. The electrochemical energy-storage cell of claim 7, wherein the electrochemical energy-storage cell is a lithium cell.

9. The electrochemical energy-storage cell of claim 27, wherein the NO active material comprises one or more transition metals that include nickel, with the nickel present in a stoichiometric range, relative to the one or more transition metals, of 33%, ±20%, to 100%, ±20%.

10. The electrochemical energy-storage cell of claim 9, wherein the MP active material comprises iron phosphate.

11. The electrochemical energy-storage cell of claim 9, wherein the MP active material comprises manganese iron phosphate.

12. The electrochemical energy-storage cell of claim 9, wherein the electrochemical energy-storage cell is a lithium cell.

13. The electrochemical energy-storage cell of claim 12, wherein each of the plurality of anodes is a plating/stripping anode.

14. The electrochemical energy-storage cell of claim 9, wherein the NO active material comprises a layered Ni-containing oxides.

15. The electrochemical energy-storage cell of claim 14, wherein the NO material contains nickel in a stoichiometric range, relative to amounts of non-lithium metal elements, of 50%, ±20%, to 100%, ±20%.

16. The electrochemical energy-storage cell of claim 14, wherein the MP active material comprises iron phosphate.

17. The electrochemical energy-storage cell of claim 14, wherein the MP active material comprises manganese iron phosphate.

18. The electrochemical energy-storage cell of claim 14, wherein the electrochemical energy-storage cell is a lithium cell.

19. The electrochemical energy-storage cell of claim 18, wherein each of the plurality of anodes is a plating/stripping anode.

20. The electrochemical energy-storage cell of claim 27, wherein the MP active material comprises iron phosphate.

21. The electrochemical energy-storage cell of claim 27, wherein the MP active material comprises manganese iron phosphate.

22. The electrochemical energy-storage cell of claim 27, comprising a plurality of the first cathodes and a plurality of the second cathodes.

23. The electrochemical energy-storage cell of claim 22, wherein the first cathodes and the second cathodes are stacked interdigitatingly relative to one another.

24. The electrochemical energy-storage cell of claim 23, wherein the first and second cathodes alternate one by one with one another.

25. The electrochemical energy-storage cell of claim 27, wherein the plurality of cathodes are provided in a number C and the at least one second cathode is provided in a number P, wherein a %-ratio of P to C is less than 50%.

26. The electrochemical energy-storage cell of claim 27, wherein the plurality of cathodes are provided in a number C and the at least one second cathode is provided in a number P, wherein a %-ratio of P to C is less than 40%, ±20%.

27. An electrochemical energy-storage cell that, when the electrochemical energy-storage cell is at least partially charged and is electrically connected to an external electrical circuit, provides an energy output, the electrochemical energy-storage cell comprising:
a housing;
an electrolyte contained within the housing;
a core that is contained in the housing and is in operative relationship with the electrolyte, wherein the core includes:
a plurality of anodes;
a plurality of O-cathodes each comprising nickel-containing-oxide (NO) active material; and
a plurality of P-cathodes each comprising metal-containing-phosphate (MP) active material; and
a plurality of separators;
wherein the plurality of anodes, the plurality of cathodes, and the plurality of separators are arranged to form a stack in which each of the plurality of separators is located between a corresponding anode-cathode pair composed of one of the plurality of anodes and one of the plurality of cathodes; and
a positive terminal and a negative terminal that, when the electrochemical energy-storage cell is at least partially charged and the positive and negative terminals are electrically connected to the external electrical circuit, provide the energy output of the electrochemical energy-storage cell;
wherein:
the anodes and the O-cathodes are electrically connected between the positive and negative terminals so as to contribute to providing the energy output of the electrochemical energy-storage cell;
at least one of the P-cathodes is not electrically connected between the positive and negative terminals so as to not contribute to providing the energy output of the electrochemical energy-storage cell.

28. The electrochemical energy-storage cell of claim 27, wherein the electrolyte comprises one or more anhydrous organic solvents.

29. The electrochemical energy-storage cell of claim 27, wherein:
the electrochemical energy-storage cell has a first thermal-runaway-initiation temperature; and
a baseline electrochemical energy-storage cell has a second thermal-runaway-initiation temperature, wherein the baseline electrochemical energy-storage cell is identical to the electrochemical energy-storage cell but that includes only a plurality of the at least one first cathode;
wherein the first thermal-runaway-initiation temperature is greater than the second thermal-runaway-initiation temperature due to the presence of the at least one second cathode in the electrochemical energy-storage cell of claim 27.

30. A battery module having an aggregated energy output, comprising:
a housing; and
a plurality of the electrochemical energy-storage cell of claim 27 contained within the housing and electrically connected with one another so as to provide the aggregated energy output of the battery module.

31. The electrochemical energy-storage cell of claim 27, wherein all of the P-cathodes are next-never electrically connected between the positive and negative terminals so as to not contribute to providing the energy output of the electrochemical energy-storage cell.

32. The electrochemical energy-storage cell of claim 27, wherein each of the P-cathodes that is not electrically connected between the positive and negative terminals is idle relative to the energy output of the electrochemical energy-storage cell.

33. The electrochemical energy-storage cell of claim 27, wherein:
a first plurality of the P-cathodes are not electrically connected between the positive and negative terminals so as to not contribute to providing the energy output of the electrochemical energy-storage cell; and
a second plurality of the P-cathodes are electrically connected between the positive and negative terminals so as to contribute to providing the energy output of the electrochemical energy-storage cell.
